(19) United States
(12) Patent Application Publication
(10) Pub. No.: US 2009/0178310 A1
(43) Pub. Date: Jul. 16, 2009

(54) Card with Decoration Attaching Arrangement

(76) Inventor: Ying-Ju Chen, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/013,660

(22) Filed: Jan. 14, 2008

(51) Int. Cl. G09F 1/04

(52) U.S. Cl. 40/124.11; 40/124.04; 40/124.09

(57) ABSTRACT

Provided is a decorative card including a two-sheet folding paper including a first attaching device formed on the outer surface of one sheet thereof; and a colorful decoration formed of molded PVC, the decoration including a second attaching device for releasably attaching to the first attaching device. In one embodiment, the first attaching device is a metal member and the second attaching device is a magnet. In another embodiment, the first attaching device includes two parallel slits and the second attaching device is a paper clip adapted to insert through the slits to secure the decoration onto the folding paper. In a further embodiment, the first attaching device is a curved slit having two end openings, and the second attaching device is a chain adapted to loop through the openings by passing the slit so as to hang the decoration on the folding paper.

### BACKGROUND OF THE INVENTION

1. Field of Invention

The invention relates to cards and more particularly to a two-sheet folding card having an arrangement for releasably attaching a decoration formed of PVC (polyvinyl chloride).

2. Description of Related Art

A type of conventional card has a sheet of paper and a decoration. A person may write a message or greeting on the sheet of paper. The decoration is formed by cutting paper(s) and is secured onto the sheet of paper by gluing.

But this is unsatisfactory for the purpose for which the invention is concerned for the following reasons: The decoration is less attractive, subject to damage, and not detachable. Thus, a need for improvement exists.

### SUMMARY OF THE INVENTION

In one aspect of the invention there is provided a decorative card comprising a two-sheet folding paper including a metal member mounted on the outer surface of one sheet thereof; and a colorful decoration formed of PVC (polyvinyl chloride) by molding, the decoration including a magnet adapted to attach to the metal member by attracting.

In another aspect of the invention there is provided a decorative card comprising a two-sheet folding paper including includes two parallel slits formed on the outer surface of one sheet thereof; and a colorful decoration formed of PVC (polyvinyl chloride) by molding, the decoration including a paper clip adapted to insert through the slits to secure the decoration onto the folding paper.

In a further aspect of the invention there is provided a decorative card comprising a two-sheet folding paper including a curved slit having two end openings formed on the outer surface of one sheet thereof; and a colorful decoration formed of PVC (polyvinyl chloride) by molding, the decoration including a chain adapted to loop through the openings by passing the slit so as to hang the decoration on the folding paper.

The above and other objects, features and advantages of the invention will become apparent from the following detailed description taken with the accompanying drawings.

### BRIEF DESCRIPTION OF THE DRAWINGS

FIG. 1 is an exploded perspective view of a first preferred embodiment of card according to the invention;

FIG. 2 is an exploded perspective view of a second preferred embodiment of card according to the invention; and

FIG. 3 is a perspective view of a third preferred embodiment of card according to the invention.

### DETAILED DESCRIPTION OF THE INVENTION

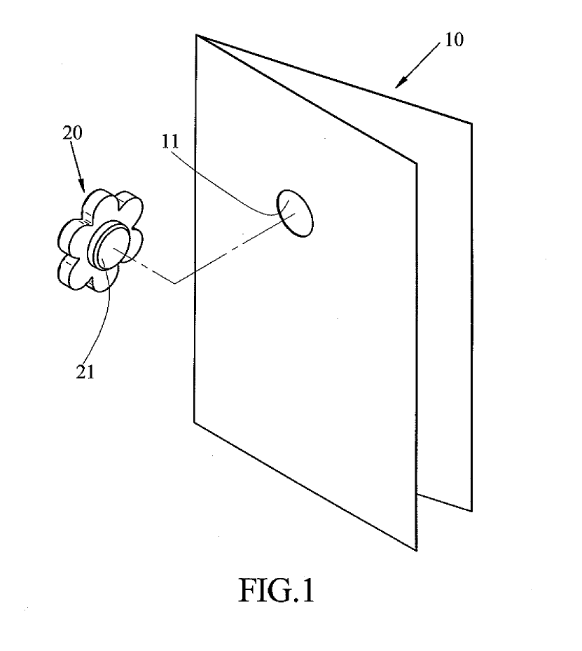

Referring to FIG. 1, a card 10 in accordance with a first preferred embodiment of the invention is shown. The two-sheet card 10 is adapted to fold, i.e., a two-sheet folding card 10. The card 10 comprises a circular metal member 11 formed on the outer surface of one sheet thereof. A decoration 20 comprises a circular magnet 21 on its rear. The magnet 21 is adapted to attach to the metal member 11 by attracting to render attractive. It is also understood that the attachment of the decoration 20 to the card 10 is releasable.

The decoration 20 as well as the other two different decorations described later are formed of PVC material by molding. Moreover, the PVC material is comprised of PVC plastic materials of different colors so that the produced decoration 20 can be colorful. In addition, the decoration 20 has an arrangement for releasably attaching to the card 10.

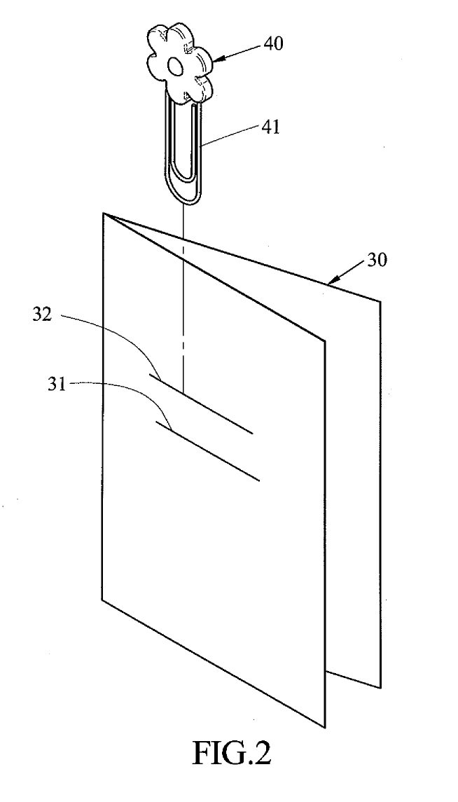

Referring to FIG. 2, a card 30 in accordance with a second preferred embodiment of the invention is shown. The characteristics of the second preferred embodiment are detailed below. The card 30 comprises two parallel slits 31, 32 on the outer surface of one sheet thereof. A decoration 40 comprises a paper clip 41 extending downward. The pair of fastening portions of the paper clip 41 is adapted to insert through the slits 31, 32 to secure the decoration 40 onto the card 30.

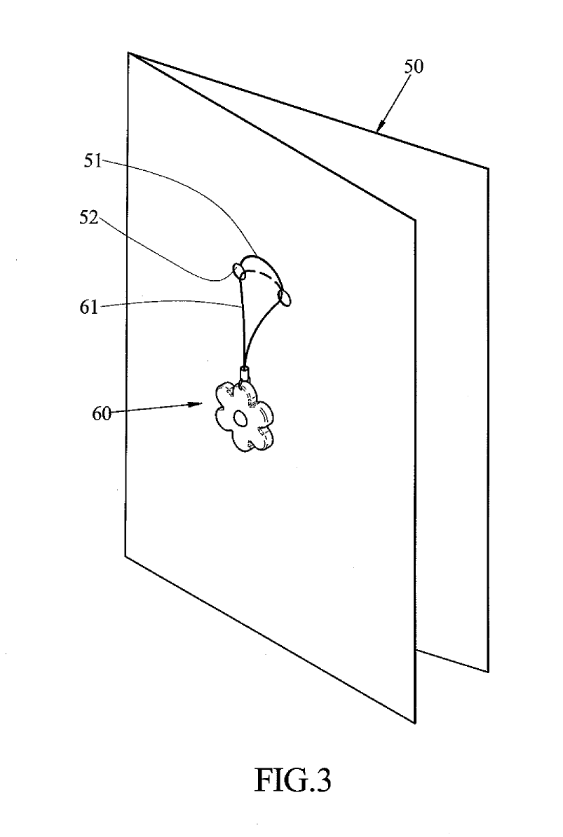

Referring to FIG. 3, a card 50 in accordance with a third preferred embodiment of the invention is shown. The characteristics of the third preferred embodiment are detailed below. The card 50 comprises a curved slit 51 having two circular end openings 52 on the outer surface of one sheet thereof. A decoration 60 has a chain 61 adapted to loop through the openings 52 by passing the slit 51 so that the decoration 60 can be hanged on the outer surface of one sheet of the card 50.

While the invention herein disclosed has been described by means of specific embodiments, numerous modifications and variations could be made thereto by those skilled in the art without departing from the scope and spirit of the invention set forth in the claims.

What is claimed is:

1. A decorative card comprising:
a two-sheet folding paper including a metal member mounted on the outer surface of one sheet thereof; and
a colorful decoration formed of PVC (polyvinyl chloride) by molding, the decoration including a magnet adapted to attach to the metal member by attracting.

2. A decorative card comprising:
a two-sheet folding paper including includes two parallel slits formed on the outer surface of one sheet thereof; and
a colorful decoration formed of PVC (polyvinyl chloride) by molding, the decoration including a paper clip adapted to insert through the slits to secure the decoration onto the folding paper.

3. A decorative card comprising:
a two-sheet folding paper including a curved slit having two end openings formed on the outer surface of one sheet thereof; and
a colorful decoration formed of PVC (polyvinyl chloride) by molding, the decoration including a chain adapted to loop through the openings by passing the slit so as to hang the decoration on the folding paper.
